(19) United States
(12) Patent Application Publication
(10) Pub. No.: US 2007/0297429 A1
(43) Pub. Date: Dec. 27, 2007

(54) Media flow bridging device and media service system

(75) Inventors: Yanyu Wu, Shenzhen (CN); Yu Su, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: HUAWEI TECHNOLOGIES CO., LTD.

(21) Appl. No.: 11/896,568

(22) Filed: Sep. 4, 2007

Related U.S. Application Data
(63) Continuation-in-part of application No. PCT/CN2006/002797, filed on Oct. 20, 2006.

(30) Foreign Application Priority Data
Feb. 28, 2006 (CN) 2006-10034088.4

(51) Int. Cl. H04L 12/56; H04J 3/16

(52) U.S. Cl. 370/401; 370/466

(57) ABSTRACT

A media flow bridging device includes a control module for receiving control message, performing media negotiation and controlling service process; and an RTP module connected with the control module, for processing RTP protocols and transferring media flows. A system for media service includes: a control device for processing signaling and controlling service process; a media resource device connected with the control device, for providing media resource; and a media flow bridging device connected with the control device and the media resource device, wherein the media resource device transfers media flow to or from a device exterior to the system via the media flow bridging device. The invention can achieve functions such as operator quality control, automatic manual service switch, automatic service switch and etc. in a broadband network if media flows are exchanged between a user terminal and a resource device point-to-point through RTP directly in the broadband network.

### CROSS-REFERENCE TO RELATED APPLICATION

This application is a CIP of International Application No. PCT/CN2006/002797 filed Oct. 20, 2006, designating the United States and claiming priority from Chinese Patent Application No. 200610034088.4 filed on Feb. 28, 2006. The subject matter of both foregoing applications is incorporated herein by reference.

### FIELD OF THE INVENTION

The present invention relates to media service, and in particular, to a media flow bridging device and a media service system that can realize media flow multi-negotiation.

### BACKGROUND OF THE INVENTION

In comparison with a narrowband network, a broadband network can provide more abundant media resources to users. Although the network has entered into an era of broadband, the application of automatic and manual services of Call Centers and Intelligent Networks that largely exist in a narrowband network will not be changed greatly in a short period because people's habit in using networks is hard to change. Some widely accepted services in a narrowband network will be used in a broadband network inevitably. Most typically, automatic services or manual services in Call Centers or Intelligent Networks are still indispensable in broadband networks.

In a narrowband network, service applications such as Automatic-To-Manual, Manual-To-Automatic and Voice-To-Fax, etc., may often appear in the services of a Call Center. Such service applications are usually realized by modifying lap joints of narrowband timeslot in a switching module of an exchanger or system so as to lap-joint a user call to different resources (voice, fax, manual operator and so on). Thus, continuous switches between services may be accomplished. Such operations are all performed in the interior of a system, and they are completely transparent to users or user terminals.

However, in a broadband network, with call being separated from bearing, a call control device will no longer be provided with the function of bearing, and a bearing network will evolve into IP networks. As a result, the point-to-point exchange of media flow is realized between a user terminal and a system resource (voice, image, fax, manual operator and so on) through RTP (Real-time Transport Protocol) directly, which will bring difficulties for some of the traditional services. Specifically, it is difficult for the operator to perform quality control function (inserting, monitoring, recording, etc.), because a user terminal and a manual operator interact in an end-to-end mode with the RTP media flows therebetween not going through a call control device in the system. On the other hand, in a broadband network, there is some restriction on the support of multiple media negotiation: an H.323 terminal does not support a second media negotiation; an SIP (Session Initiation Protocol) terminal supports a second negotiation, but it is not a mandatory requirement; and even if a terminal supports a second negotiation, it will depend on whether its opposite terminal supports a second media negotiation if the opposite end device accesses a call in MGC+MGW mode, and even if the opposite end device supports a second negotiation, there may be a larger time delay.

In the prior art, after a user, such as a 3G terminal, an H.323 terminal or an SIP terminal etc., accesses a system, it may be accessed to different resources according to a service flow. Usually, it is first accessed to a voice resource, which provides information such as service use directions; and according to different user requirements, it is possible that the user requires fax service, operator service, meeting access service or other services. This will inevitably require that the media flow of the terminal is switched from the voice resource device to the fax, the manual operator or the conference place. However, if the terminal or the exterior network device does not support a second media negotiation and modification, this function will not be realized. Moreover, an H.323 terminal does not support a second media negotiation; a SIP terminal protocol supports a second media negotiation, but it is not a mandatory requirement. If a terminal supports a second negotiation, it will depend on whether its opposite end device supports a second media negotiation if the opposite end device accesses a call in MGC+MGW mode. Even if the opposite end device supports a second negotiation, there may be greater time delay. On the other hand, after a user accessed to a manual operator, the media flow is exchanged between the user terminal and the manual operator through RTP directly, which will bring some difficulties for the system quality control staff in monitoring or recording the session.

Therefore, with bearing networks evolving into IP networks, difficulties will arise when some widely accepted services (typically, such as automatic services or manual services in Call Centers or Intelligent Networks) in the traditional narrowband networks are shifted into IP networks. Service switch among various resources (such as voice, video, image, fax, manual operator, etc.) can not be realized because broadband networks restrict support of a second media negotiation.

### SUMMARY OF THE INVENTION

The invention provides a media flow bridging device and a media service system, which supports functions such as resource switch, manual operator quality control, etc., which are needed by the system to carry out various services.

The invention is implemented by the following technical solutions.

A media flow bridging device is provided. The media flow bridging device includes: a control module and a real-time transparent protocol (RTP) module connected with the control module, wherein the control module is capable of receiving a control message, performing media negotiation and controlling a service flow; and the RTP module is capable of processing RTP protocols and transferring a media flow according to control information of the control module.

According to an embodiment of the invention, the RTP module includes: an RTP source module connected with the control module, and an RTP destination module connected with the control module and the RTP source module, wherein the RTP source module is capable of transferring a media flow to a user terminal or transferring a media flow from the user terminal; and the RTP destination module is capable of transferring a media flow to a media resource device or transferring a media flow from the media resource device, wherein the media resource device provides media resources.

The device further includes: at least one of a code conversion module and an audio mixing module, wherein the code conversion module is capable of converting code format of a media flow; and the audio mixing module is capable of performing audio mixing on media flows of all conference parties during a multiparty session.

At least one of the code conversion module and the audio mixing module is arranged between the RTP source module and the RTP destination modules, and the at least one of the code conversion module and the audio mixing module is capable of connecting the RTP source module with at least two RTP destination modules.

A system for media service is provided, which includes a control device, capable of processing signaling and controlling a service flow; a media resource device connected with the control device, capable of providing media resources; and a media flow bridging device connected with the control device and the media resource device, wherein the media resource device transfers a media flow to or from a device exterior to the media service system via the media bridging device.

A method of transferring a media flow is provided, which includes: receiving a control message, performing media negotiation and controlling a service process; processing RTP protocols and transferring a media flow according to the control message.

It can be seen from the above technical solutions provided by embodiments of the present invention that the technical solutions of the present invention can solve the problems in such as operator quality control, automatic-manual service switch and automatic service switch etc in a broadband network which arise when a media flow is exchanged between a user terminal and a resource device (voice, image, fax and manual operator, etc.) point-to-point through RTP directly in the broadband network.

### BRIEF DESCRIPTION OF THE DRAWINGS

FIG. 1 is a structural diagram of a media service system in accordance with an embodiment of the present invention;

FIG. 2 is a structural diagram of a media flow bridging device in accordance with an embodiment of the present invention;

FIG. 3 is a structural diagram of an RTP module of a media flow bridging device in accordance with an embodiment of the present invention;

FIG. 4 is a structural diagram of a media flow bridging device in accordance with an embodiment of the present invention;

FIG. 5 is a structural diagram of an RTP module of a media flow bridging device in accordance with another embodiment of the present invention;

FIG. 6 is a structural diagram of a media flow bridging device in accordance with an embodiment of the present invention; and

FIG. 7 is a structural diagram of a media flow bridging device in accordance with another embodiment of the present invention.

### DETAILED DESCRIPTION OF THE EMBODIMENTS

To solve the problem that manual service quality control and automatic flow switch are restricted in a broadband network, according to an embodiment of the present invention, a media flow bridging device is added in a call center of a broadband network or a resource platform of an intelligent network (including other similar systems) or provided independently in order to achieve broadband media flow access. Functions, such as media switch, media flow copying and distributing, can be realized through connecting the media flow bridging device to various media resource devices in the system, and functions, such as resource switch, manual operator quality control, which are needed by the system to carry out various services, are therefore being supported.

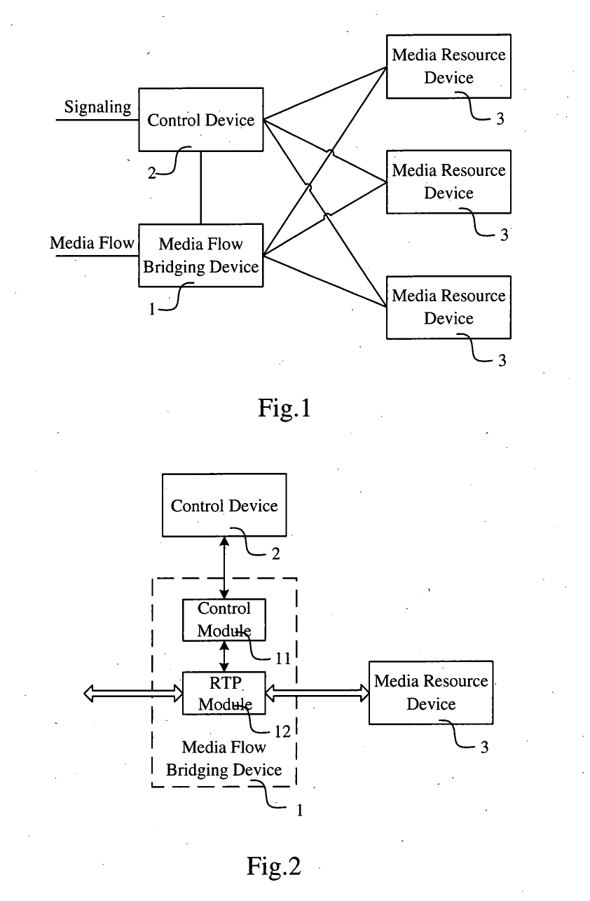

FIG. 1 shows a structural diagram of a media service system according to an embodiment of the invention. The system includes: a media flow bridging device 1, a control device 2 and a plurality of media resource devices 3. The control device 2 is connected with the media flow bridging device 1 and the media resource devices 3, for processing signaling and controlling service flows. The media resource device 3 is used for providing media resources and is connected with the media flow bridging device 1, for transferring a media flow to or from a device exterior to the media service system via the media flow bridging device 1. The media resource device 3 may be: a voice device (playing, recording and number receiving), a fax device (transceiving a fax), a multimedia device (multimedia playing and recording), a manual agent, or various combinations thereof. The control device may be: a Service Control Point (SCP) of an Intelligent Network, a CTI (Computer Telephony Integration) Server of a Call Center, a combination thereof, an MRFC (Media Resource Function Controller) of an IMS (Information Management System), other devices with similar functions, and so on.

FIG. 2 shows a structural diagram of a media flow bridging device according to an embodiment of the invention. The device includes a control module 11 and an RTP module 12. The control module 11 is used for receiving control messages, performing media negotiation and controlling service flows. The RTP module 12 is connected with the control module 11, for processing RTP protocols and transferring media flows according to control information of the control module. In this figure and the following figures, “ [symbol] ” means that information transferred is a control command, and “ [symbol] ” means that information transferred is a media flow.

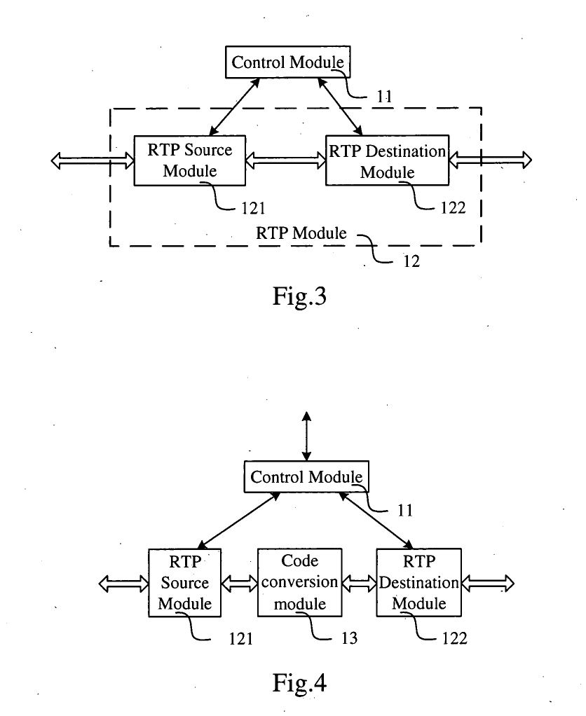

The RTP module may include a plurality of submodules, for communicating with a user terminal and a media resource device respectively. FIG. 3 is a structural diagram of an RTP module according to one embodiment of the invention, which includes a RTP source module 121 and an RTP destination module 122 connected with each other, and both of the modules are connected with the control module 11. The RTP source module 121 is used for transferring a media flow to or from a user terminal. The RTP destination module 122 is used for transferring a media flow to or from a media resource device that provides media resources.

When the user terminal and the media resource device employ different media code formats, the code format of the media flow needs to be converted, and the media flow will then be forwarded after the conversion is completed. FIG. 4 is a structural diagram of a media flow bridging device according to an embodiment of the invention, which includes a control module 11, an RTP source module 121, a code conversion module 13 and an RTP destination module 122. The control module 11 is connected with all of the other modules, for controlling each of them to accomplish functions required by the system. The RTP source module 121 is connected with the RTP destination module 122 via the code conversion module 13. The code conversion module 13 is used for converting the code format of a media flow in accordance with media formats supported by the user terminal and the media resource device.

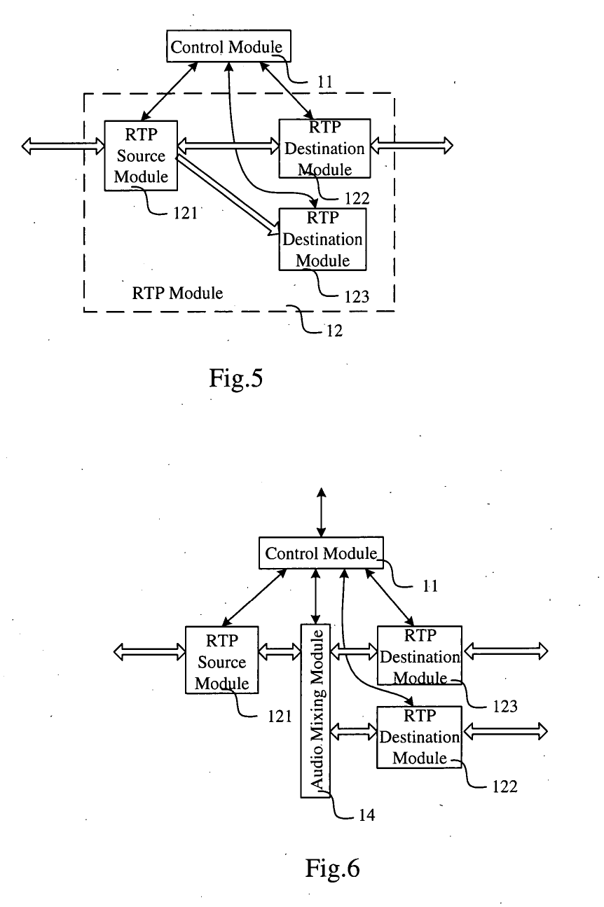

When required to communicate with a plurality of media resource devices, the RTP module may include two or more RTP destination modules. FIG. 5 is a structural diagram of an RTP module according to another embodiment of the invention. The RTP module 12 includes an RTP source module 121 and RTP destination modules 122, 123. The RTP source module 121 is used for transferring a media flow to or from a user terminal. The RTP destination modules 122 and 123 are used for transferring media flows to or from a media resource device. A media resource device connected to the RTP destination module 122 may perform two-way media interaction with a user terminal connected to the RTP source module 121. However, the media resource device connected to the RTP destination module 123 can only receive a media flow from a user terminal, but cannot send a media flow to the user terminal. In such a situation, the media flow bridging device may copy the media flow of the source end (the user side) and send them to a third party endpoint, which can be applicable for monitoring or third party recording. When the media format supported by the user terminal is different from that supported by the media resource device, a code conversion module may also be added.

To realize multiparty services and make a user terminal able to perform a two-way media flow transfer with a plurality of media resource devices, an audio mixing device may be added. FIG. 6 shows a structural diagram of a media flow bridging device according to one embodiment of the invention. The media flow bridging device includes a control module 11, an audio mixing module 14, an RTP source module 121 and RTP destination modules 122, 123. The control module 11 is connected with the audio mixing module 14, the RTP source module 121 and the RTP destination modules 122, 123, for controlling each of the modules to accomplish functions required by the system. The RTP source module 121 is connected with the RTP destination modules 122 and 123 via the audio mixing module 14 which mixes media flows from various parties. Therefore the multiparty service can be achieved, in which all the media resource devices connected to the RTP destination modules 122 and 123 may perform the two-way media flow transfer with the user terminals connected to the RTP source module 121.

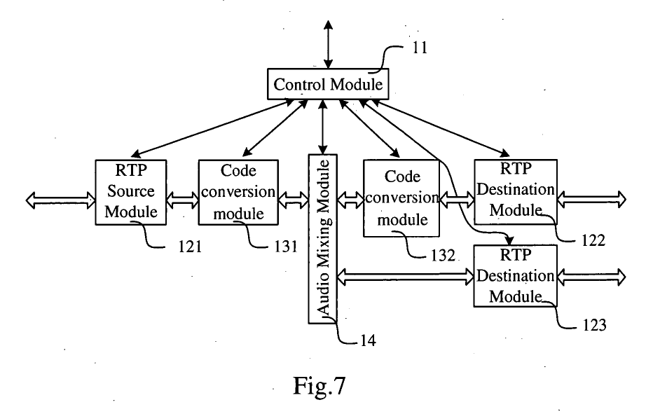

In a multiparty service, a code conversion module may also be added because code formats supported by different conference parties may be different, and the audio mixing module performs audio-mixing in one code format for the same meeting site, which requires that different formats be firstly converted into a common intermediate format for audio-mixing. FIG. 7 shows a structural diagram of a media flow bridging device according to another embodiment of the invention. In this embodiment, the code formats supported by the user terminal and the media resource device connected with the RTP destination module 122 are different from that supported by the audio mixing module 14. While the media format supported by the media resource device connected with the RTP destination module 123 is the same with that supported by the audio mixing module 14. Therefore, the RTP source module 121 is connected with the audio mixing module 14 via a code conversion module 131. The audio-mixing module 14 is connected with the RTP destination module 122 via a code conversion module 132. The audio mixing module 14 is connected with the RTP destination module 123 directly. The control module 11 is connected with each of the other modules, for controlling each of the modules to accomplish system functions.

In addition, when there is a need to record a media flow, a recording module may also be added. The recording module is connected with the control module, for recording media flow data, e.g. audio, video or graphic data, according to control information of the control module, and the recording module is also connected with corresponding modules according to media code format requirements and specific recording needs. For example, when the media resource connected with the RTP destination module is a manual operator, if quality control needs to be performed on the manual operator, the recording module may be connected with the RTP destination module and record the audio media flow. In a multiparty service, if there is a need to record the media flow of the whole meeting site, the recording module may be connected with the audio mixing module and record the audio-video media flow of the meeting site as needed.

The media flow bridging device achieves media flow bridging function between a user terminal and a media resource device, i.e. all media flows of all calls accessing the system are directly accessed to the media flow bridging device, rather than being accessed to directly to the media resource device. The media flow bridging device then establishes a media flow connection to a corresponding resource device. When the service needs switch among different resources, only the media flow bridging device needs to be controlled, so that the media flow bridging device is connected to different resources. Thus the user terminal may be switched to different resource device. When the format of the media flow provided by the resource to be switched to is not the media flow format supported by the user terminal, the media flow bridging device may accomplish the corresponding code format conversion. The above operations are completely transparent to the user terminal.

An embodiment of the invention also provides a method of transferring a media flow, according to which a media flow is directly accessed to the media flow bridging device, which at the same time receives a control message, and the media flow bridging device transfers the media flow according to the received control message.

When a service needs to perform switch between different resources, the media flow bridging module transfers a received media flow to a corresponding resource, thus the function of switching a user terminal to different resources can be accomplished.

When the code format of the media flow supported by a resource to be switched to (generally a call receiving party) is different from that supported by a user terminal, the media flow bridging device can accomplish a corresponding code conversion and then switch the media flow to the corresponding resource.

When quality control needs to be performed on a manual operator after a user terminal is connected to the manual operator, the media flow bridging device copies the media flow between the user terminal and the manual operator and delivers it to the quality control staff or a recording system. So that functions such as inserting, monitoring, recording or even three-party calling can be accomplished.

The media flow bridging device can also select the media flows from two parties or multi-parties, and mix the selected media flows. Thus multiparty session can be accomplished.

In the invention, the existing services such as automatic service process, manual operator may be realized in a broadband (NGN, 3G, VOIP) network, and the invention solves problems in such as operator quality control, automatic manual service switch, automatic service switch that arise when media flows are exchanged between a user terminal and a resource device (voice, image, fax, manual operator, etc.) point-to-point through RTP directly in a broadband network.

In the specification, the term “Media negotiation” means that when different media interact with each other, due to their different capabilities, negotiation between these media may be required in order to carry out intercommunications therebetween. A procedure of negotiation is a procedure of establishing a connection. The above explanation should not be construed as limiting the scope of the invention.

Additional advantages and modifications will readily occur to those skilled in the art. Therefore, the invention in its broader aspects is not limited to the specific details and representative embodiments shown and described herein. Accordingly, various modifications and variations may be made without departing from the spirit or scope of the invention as defined by the appended claims and their equivalents.

What is claimed is:

1. A media flow bridging device, comprising:
a control module and a real-time transparent protocol (RTP) module connected with the control module, wherein,
the control module is capable of receiving a control message, performing media negotiation and controlling a service process; and
the RTP module is capable of processing RTP protocols and transferring a media flow according to control information of the control module.

2. The media flow bridging device according to claim 1, wherein the RTP module comprises:
an RTP source module connected with the control module, and
an RTP destination module connected with the control module and the RTP source module, wherein,
the RTP source module is capable of transferring a media flow to a user terminal or transferring a media flow from the user terminal; and
the RTP destination module is capable of transferring a media flow to a media resource device or transferring a media flow from the media resource device, wherein, the media resource device provides media resources.

3. The media flow bridging device according to claim 2, wherein the number of the RTP destination modules is at least two.

4. The media flow bridging device according to claim 2, further comprising:
at least one of a code conversion module and an audio mixing module, wherein,
the code conversion module is capable of converting code format of a media flow; and
the audio mixing module is capable of performing audio mixing on media flows of all conference parties during a multiparty service.

5. The media flow bridging device according to claim 4, wherein: at least one of the code conversion module and the audio mixing module is arranged between the RTP source module and the RTP destination module, and the at least one of the code conversion module and the audio mixing module is capable of connecting the RTP source module with at least two RTP destination modules.

6. The media flow bridging device according to claim 4, further comprising:
a recording module connected with the control module and the audio mixing module, wherein,
the recording module is capable of recording media data.

7. The media flow bridging device according to claim 1, further comprising:
a recording module connected with the control module, wherein,
the recording module is capable of recording media data.

8. A system for media service, comprising:
a control device, a media resource device connected with the control device and a media flow bridging device connected with the control device and the media resource device, wherein,
the control device is capable of processing signaling and controlling a service process;
the media resource device is capable of providing media resources and is capable of transferring a media flow to or from a device exterior to the media service system via the media flow bridging device.

9. The system for media service according to claim 8, wherein the media flow bridging device comprises:
a control module and a real-time transparent protocol (RTP) module connected with the control module, wherein,
the control module is capable of receiving a control message, performing media negotiation and controlling a service process; and
the real-time transparent protocol (RTP) module is capable of processing RTP protocols and transferring a media flow according to control information of the control module.

10. A method of transferring a media flow, comprising
receiving a control message,
performing media negotiation and controlling a service process;
processing RTP protocols and transferring a media flow according to the control message.

11. The method according to claim 10, further comprising
converting the media code format before transferring the media code format, if a transmitting party and a receiving party of the media flow employ different media code formats.

12. The method according to claim 10, wherein
the transferring a media flow according to the control message further comprises: copying the media flow and sending the copied media flow to a third party.

13. The method according to claim 10, wherein
the transferring a media flow according to the control message further comprises: mixing the media flow.
